(19) United States
(12) Patent Application Publication
(10) Pub. No.: US 2024/0232911 A1
(43) Pub. Date: Jul. 11, 2024

(54) SYSTEM AND METHOD FOR SUPPLIER INTERFACE BETWEEN ENTITIES IN A GAMING ENVIRONMENT

(71) Applicant: Merydyan Technologies LLC, Appleton, WI (US)

(72) Inventors: Dennis Michael Sheldon, Jr., Shawano, WI (US); Debra Chase-Mosley, Neenah, WI (US)

(21) Appl. No.: 18/405,984

(22) Filed: Jan. 5, 2024

Related U.S. Application Data
(60) Provisional application No. 63/437,476, filed on Jan. 6, 2023.

(51) Int. Cl. G06Q 30/018

(52) U.S. Cl. CPC G06Q 30/018

(57) ABSTRACT

A system and method includes a database configured to store data from a Gaming Supplier and a Gaming Operation, a computing system configured to communicate with the database, and an application executable by a processor of a computing device to execute an algorithm of instructions to transmit data from most recent employee application to the Gaming Operation, access the system by the Gaming Supplier to update the employee application with any changes, transmit and manage the updated employee application by the system, ensure compliance with licensure requirements based on the updated employee application, maintain employee application through end of life, and send notification to the Gaming Operation and the Gaming Supplier of non-compliance.

### CROSS-REFERENCE TO RELATED APPLICATION(S)

The present application claims the benefit of and priority to U.S. Provisional Patent Application Ser. No. 63/437,476, filed Jan. 6, 2023, the entire disclosure of which is hereby expressly incorporated by reference.

### BACKGROUND OF THE INVENTION

### Field of the Invention

The present disclosure relates generally to a gaming environment and, more specifically, to a system and method for a supplier interface between entities in a gaming environment.

### Description of Related Art

It is known that a Gaming Operation such as a casino has one or more gaming machines to allow patrons to gamble. The Gaming Industry is heavily regulated, and employee licensure must be closely monitored and controlled. For example, an unlicensed employee may expose the Gaming Operation to potential fraud and excessive fines.

Gaming Suppliers, many of whom serve hundreds of clients such as Gaming Operations, are responsible for managing communications and regulatory concerns, uniquely with each client. These regulatory concerns include licensure of every supplier employee with every client, as well as the unique laws to each client or jurisdiction pertaining to shipping of new software, hardware, and gaming machines to these clients. These Gaming Suppliers must access many different systems, with different configurations, to manage these things. Many times, a Gaming Supplier has an entire team to manage just these requirements.

Gaming Suppliers are burdened with maintaining licensure in a timely manner, for many employees in many cases. This means a different system and format for each employee at each client site. Employees and the licensing compliance team spend hours on individual applications. These hours equate to a significant amount of lost time and revenue.

These Gaming Suppliers also must maintain a library of shipping laws, unique to each client or jurisdiction. When changes are made to these rules, Gaming Suppliers are not always notified and no centralized method for managing these rules exists.

The present disclosure is aimed at solving one or more of the above-identified needs.

### SUMMARY OF THE INVENTION

The present invention provides a system including a database configured to store data from a Gaming Supplier and a Gaming Operation, a computing system configured to communicate with the database, and an application executable by a processor of a computing device and to communicate with the computing system. The application is configured to have the processor execute an algorithm of instructions to transmit data from most recent employee application to the Gaming Operation, access the system by the Gaming Supplier to update the employee application with any changes, transmit and manage the updated employee application by the system, ensure compliance with licensure requirements based on the updated employee application, maintain employee application through end of life, and send notification to the Gaming Operation and the Gaming Supplier of non-compliance.

The present invention also provides a method including the steps of storing, in a database, data associated with a Gaming Supplier and a Gaming Operation, enabling, by a computing system, a computing device of a user to access the database, executing an application by a processor of a computing device to communicate with the computing system, wherein the application is configured to have the processor execute an algorithm of instructions transmitting, by a computing system, data from most recent employee application to the Gaming Operation, accessing, by the computing system, by the Gaming Supplier to update the employee application with any changes, transmitting and managing, by the computing system, the updated employee application, ensuring, by the computing system, compliance with licensure requirements based on the updated employee application, maintaining, by the computing system, employee application through end of life, and sending, by the computing system, notification to the Gaming Operation and the Gaming Supplier of non-compliance.

One advantage of the present invention is that a system and method is provided for a supplier interface between entities within a gaming environment. Another advantage of the present invention is that the system and method is a single, easy to manage interface that will significantly reduce the burden on Gaming Suppliers for managing licensure and shipping regulations, among other things. Yet another advantage of the present invention is that the system and method allow a Gaming Supplier to sign into a single location to process their license applications and submit shipment notifications. Still another advantage of the present invention is that the system and method provide a single interface for Gaming Suppliers to use and manage their licensure and shipping rules across many different clients such as Gaming Operations, significantly reducing the amount of time required per employee to support these regulatory requirements. A further advantage of the present invention is that the system and method manage these compliance issues that are reduced significantly, resulting in a large cost savings and efficiency gain to Gaming Suppliers.

Other advantages and features of the present disclosure will be readily appreciated, as the same becomes better understood, by reference to the subsequent detailed description, when considered in connection with the accompanying drawings.

### BRIEF DESCRIPTION OF THE DRAWINGS

Non-limiting and non-exhaustive embodiments of the present invention are described with reference to the following figures, wherein like numerals refer to like parts throughout the various views unless otherwise specified.

FIG. 1 is a block diagram illustrating an exemplary system for a supplier interface between entities in a gaming environment, according to one embodiment of the present invention.

FIG. 2 is a block diagram of a computing device that may be used with the system shown in FIG. 1.

FIG. 3 is a flow diagram of a workflow that may be used with the system shown in FIG. 1.

FIG. 4 is a block diagram of a method for a supplier interface between entities in a gaming environment that may be used with the system shown in FIG. 1.

### DETAILED DESCRIPTION OF THE PREFERRED EMBODIMENT(S)

In the following description, numerous specific details are set forth to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an examples” means that a particular feature, structure or characteristic described in connection with the embodiment of example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system”. Furthermore, the present invention may take the form of a computer program product embodied in any tangible media or expression having computer-usable program code embodied in the media.

Any combination of one or more computer-usable or computer-readable media (or medium) may be utilized. For example, a computer-readable media may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisional via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The block diagram(s), flow diagram(s), and flowchart(s) illustrate the architecture, functionality, and operation of possible implementations of systems, methods, and computer program products according to various embodiments of the present invention. In this regard, each block in the flowchart, flow diagrams, or block diagrams may represent a module, segment, or portion of code, which comprises one or more executable instructions for implementing the specified logical function(s). It will also be noted that each block of the block diagrams, flow diagrams, and/or flowchart illustrations, and combinations of blocks in the block diagrams, flow diagrams, and/or flowchart illustrations, may be implemented by special purpose hardware-based systems that perform the specified functions or acts, or combinations of special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart, flow diagram, and/or block diagram block or blocks.

Several (or different) elements discussed below, and/or claimed, are described as being “coupled”, “in communication with” or “configured to be in communication with”. This terminology is intended to be non-limiting, and where appropriate, be interpreted to include without limitation, wired and wireless communication using any one or a plurality of suitable protocols, as well as communication methods that are constantly maintained, are made on a periodic basis, and/or made or initiated on an as needed basis.

The present disclosure particularly describes a system and method for a supplier interface between entities in a gaming environment in a single, easy to manage interface that will significantly reduce the burden on Gaming Suppliers for managing licensure and shipping regulations, among other things. The present disclosure provides a system and method for a supplier interface between entities in a gaming environment that implements a mode called API mode and connects to individual regulatory sites via API mode to retrieve and synchronize license information, as well as shipping regulations. In the present disclosure, the Gaming Regulator uses this information to make more timely decisions on whether a Gaming Operation is compliant with licensure for their employees. In the present disclosure, the supplier interface is used to manage Gaming Suppliers licensure and shipping rules, significantly reducing the amount of time required per employee to support regulatory requirements.

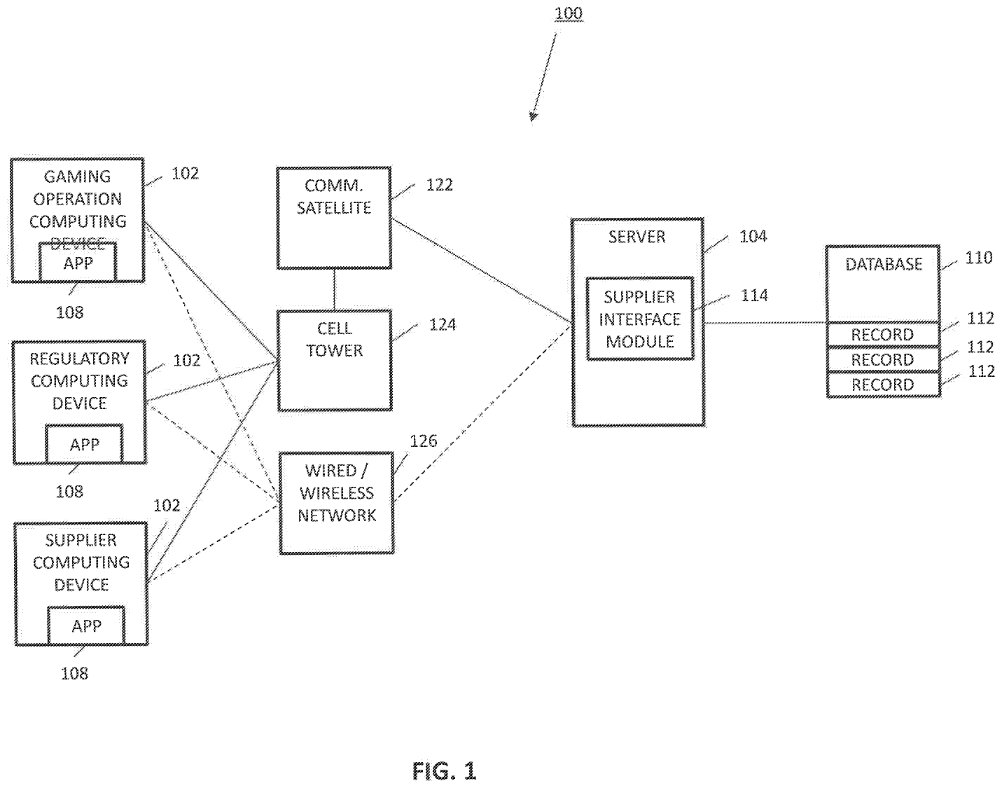

FIG. 1 is a block diagram of an exemplary system 100 that may be used for a supplier interface between entities in a gaming environment. To implement this supplier interface, the system 100 is implemented for one or more regulatory clients such as Gaming Operation(s) or Gaming Supplier(s). In one embodiment, the system 100 includes one or more computing devices such as a Gaming Operation computing device 102, a Gaming Regulator computing device 102, and a Gaming Supplier computing device 102. The system also includes a server 104 connected or in communication with the Gaming Operation computing device 102, the Regulator computing device 102, and the Gaming Supplier computing device 102. The various components of the system 100 may be connected together by one or more wired or wireless networks. Although four computing devices 102 are illustrated in FIG. 1, the system 100 may include any suitable number of the computing devices 102. Also, while the system 100 is illustrated with the above components, it should be appreciated that one or more components of the system 100 may be combined together or split apart while remaining within the scope of the disclosure.

The computing device 102 is a computing device that may be operated by a user (sometimes referred to herein as a Gaming Operation, Gaming Regulator, and Gaming Supplier) to communicate with each other. The computing device 102 may include a mobile phone, a personal digital assistant (PDA), a tablet computer, a wearable computing device, a laptop computer, a desktop computer, a kiosk, a point-of-sale terminal, a virtual reality device, an augmented reality device, or any other suitable computing device that enables the computing device 102 to operate as described herein. In one embodiment, an application or “app” 108 is installed on each computing device 102 to enable communication with each other.

The server 104 is a computing device that enables multiple computing devices 102 to access and transmit data. In one embodiment, the server 104 stores information or data from the Supplier Interface in a database 110 that each user may access and receive the information or data from the server 104. The information may be stored in a plurality of records 112 in the database 110. The records 112 may include information or data about licensure and/or shipping laws. The server 104 may retrieve the records 112 from the database 110 by querying the database 110 during operation.

In one embodiment, the server 104 includes a Supplier Interface module 114 that can retrieve applications for license renewal, licensure rules, and shipping rules for a particular jurisdiction from the database 110. For example, the Supplier Interface module 114 may receive a single application for multiple employees from a Gaming Operation in a single application and determine whether each employee complies with local licensure rules for the particular jurisdiction, and/or any other suitable statistic.

In one embodiment, the system 100 includes devices that enable the computing devices 102 to transmit and receive data to and from the server 104. The devices may include one or more communication satellites 122, one or more cellular towers 124, and devices forming one or more wired or wireless networks 126. In one embodiment in which the computing devices 102 are cellular phones, the computing devices 102 may communicate with the server 104 by transmitting signals to the cellular tower 124 which then transmits the signals to the communication satellite 122. The communication satellite 122 transmits the signals to the server 104. In turn, the server 104 may transmit signals to the computing devices 102 in the reverse direction via the communication satellite 122 and the cellular tower 124. It should be appreciated that the computing devices 102 may communicate with the server 104 via one or more wired or wireless of the networks 126, such as the Internet.

In one embodiment, the signals transmitted between the computing devices 102 and the server 104 are encrypted using a suitable encryption algorithm. For example, the signals may be encrypted using a public key infrastructure (PKI) algorithm. In another embodiment, the signals may be encrypted using any suitable algorithm.

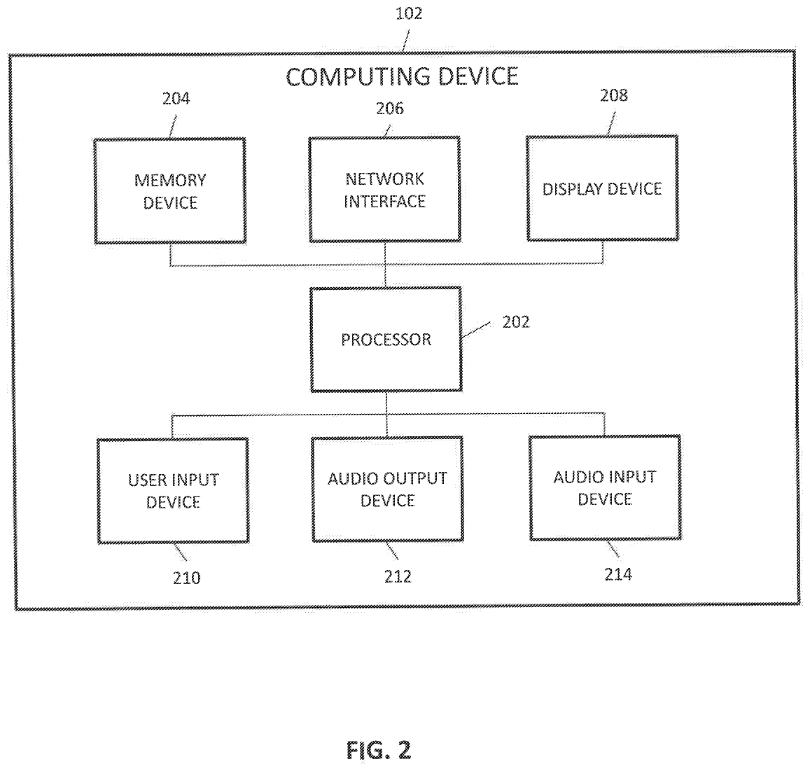

FIG. 2 is a block diagram of one embodiment of the computing device 102 that may be used with the system 100 (shown in FIG. 1). In one embodiment, the computing device 102 and server 104 described in the system 100 may be implemented as the computing device 102. However, it should be recognized that one or more components of the system 100 may not be included in the computing device 102 such as the server 104.

In one embodiment, the computing device 102 includes a processor 202, a computer-readable memory device 204, and a network interface 206. In one embodiment, the computing device 102 may also include a display device 208, an input device 210, an audio output device 212, and/or an audio input device 214. It should be appreciated that the memory device 204, network interface 206, display device 208, and input device 210 (if provided) may be connected to the processor 202 and/or to each other via any suitable bus or busses, interfaces, or other mechanisms.

The processor 202 includes any suitable programmable circuit including one or more microcontrollers, microprocessors, application specific integrated circuits (ASICs), systems on a chip (SoCs), programmable logic circuits (PLCs), field programmable gate arrays (FPGAs), and/or any other circuit capable of executing the functions described herein. The above examples are exemplary only, and thus are not intended to limit in any way the definition and/or meaning of the term “processor.”

The memory device 204 is an electronic storage device that includes one or more non-transitory computer readable medium, such as, without limitation, random access memory (RAM), flash memory, a hard disk drive, a solid-state drive, a compact disc, a digital video disc, and/or any suitable memory. The memory device 204 may include data as well as instructions that are executable by the processor 202 to program the processor 202 to perform the functions described herein. For example, the methods described herein may be performed by one or more processors 202 executing instructions stored within one or more of the memory devices 204.

The network interface 206 may include, without limitation, a network interface controller (NIC) or adapter, a radio frequency (RF) transceiver, a public switched telephone network (PSTN) interface controller, or any other communication device that enables the computing devices 102 to operate as described herein. In one embodiment, the network interface 206 may connect to the network interfaces 206 of the other user computing devices 102 of the system 100 through a network using any suitable wireless or wired communication protocol.

The display device 208 may include, without limitation, a liquid crystal display (LCD), a vacuum fluorescent display (VFD), a cathode ray tube (CRT), a plasma display, a light-emitting diode (LED) display, a projection display, a display integrated into a virtual reality or augmented reality device, and/or any suitable visual output device capable of displaying graphical data and text to a user. For example, the display device 208 may be used to display a graphical user interface associated with the application 108 to the user.

The input device 210 may include, without limitation, a keyboard, a keypad, a touch screen, a mouse, a scroll wheel, a pointing device, a video input device that registers movement of a user (e.g., usable with an augmented reality input device or a virtual reality input device), and/or any other suitable device that enables the user to input data into the computing device 102 and/or retrieve data from the computing device 102.

The audio output device 212 may include, without limitation, one or more speakers or any other device that enables content to be audibly output from the computing device 102. For example, music or other audio content associated with one or more games may be audibly output from the audio output device 212.

The audio input device 214 may include a microphone or another suitable device that enables the user to input audio commands into the computing device 102. The audio input device 214 may employ speech recognition software to convert spoken commands from the user into digital data for use in operating the computing device 102.

While the foregoing components have been described as being included within the computing devices 102, it should be appreciated that at least some of the computing devices 102 may not include each component. For example, a server may not include the audio output device 212, audio input device 214, input device 210, and/or display device 208. In addition, the computing device 102 may include any suitable number of each individual computing device component. For example, the computing device 102 may include a plurality of the processors 202 or processor cores, a plurality of the memory devices 204 (of the same or different types, sizes, etc.), and/or a plurality of the display devices 208.

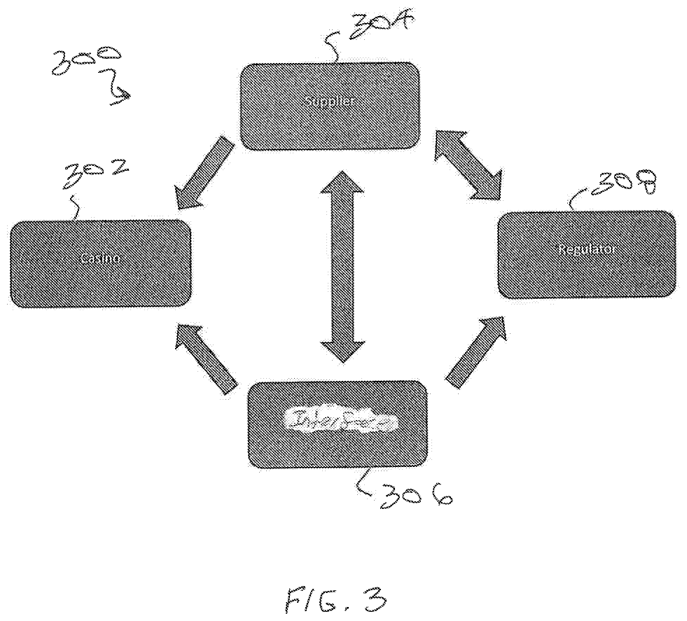

FIG. 3 is a flow diagram of a workflow 300 between entities in a gaming environment that may be used with the system 100 shown in FIG. 1. In FIG. 3, the workflow 300 includes a plurality of entities including a Gaming Operation 302 such as a casino, a Gaming Supplier 304 who supplies gaming machines to the Gaming Operation 302, and a Supplier Interface 306 of the system 100 that allows the Gaming Supplier 304 to use and manage their licensure and shipping rules across many different clients such as Gaming Operations 302. The workflow 300 also includes communication between the Gaming Supplier 304 and the Supplier Interface 306. The workflow 300 further includes a Gaming Regulator 308 that receives licensure information from the Supplier Interface 306 and communication with the Gaming Supplier 304. It should be appreciated that one or more Gaming Operation(s) 302, Gaming Supplier(s) 304, and Gaming Regulator(s) 308 may be included for the workflow 300 for the Supplier Interface 306.

For the workflow 300, using API, in a simple example, if a Gaming Supplier 304 has one hundred (100) employees that are all licensed with one hundred (100) clients such as Gaming Operations 302, and an application for license renewal is completed every year, with an average time of one (1) hour to complete each application, it is estimated that ten thousand (10,000) hours are spent annually on licensing requirements alone.

With the Supplier Interface 306, these one hundred (100) employees would submit a single application, which would then be automatically transmitted to all one hundred (100) Gaming Operations 302 each year. It should be appreciated that, on an annual basis, the hours required to complete licensing requirements is reduced from ten thousand (10,000) hours to one hundred (100).

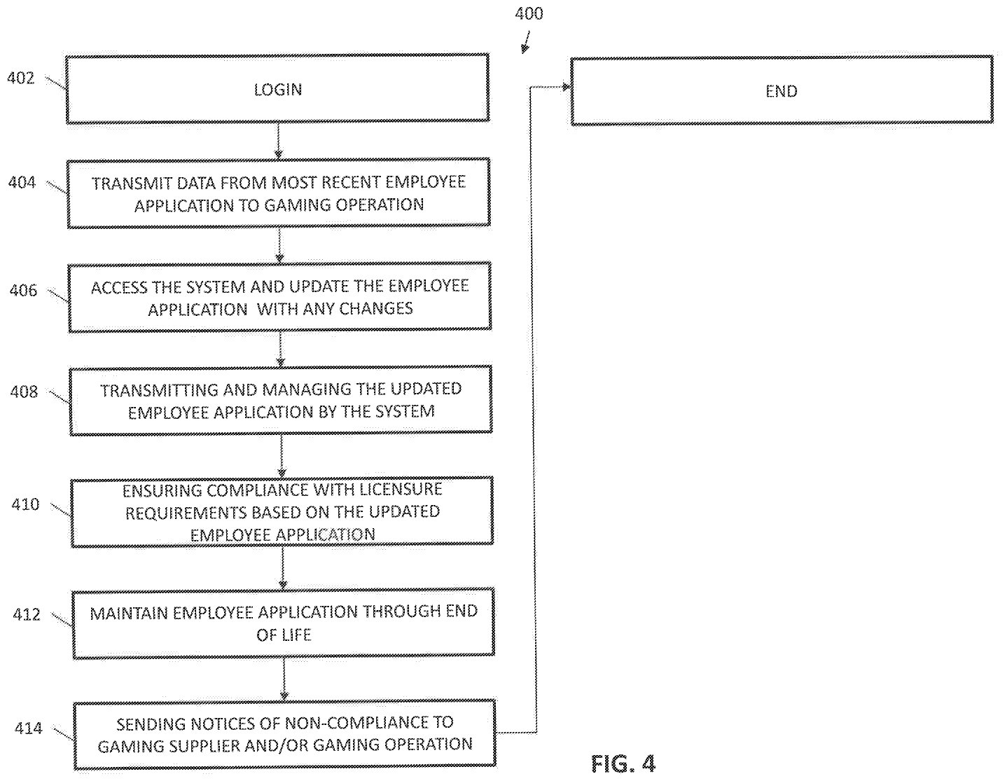

FIG. 4 is a flow diagram of an exemplary method 400 of the Supplier Interface 306 that may be used with the system 100 (shown in FIG. 1). The method 400 may be implemented by the computing device 102 and/or server 104 (shown in FIG. 1), such as by the processor 202 of the computing device 102 and/or server 104 executing an algorithm of computer-readable instructions stored within the memory device 204 of the computing device 102 and/or server 104. In another embodiment, the method 400 may be implemented by any suitable device of the system 100.

The method 400 of the Supplier Interface 306 manages license information and shipping regulations for properties or jurisdictions of Gaming Operations 302. The method 400 implementations support a mode called API mode. The Supplier Interface 306 connects to the individual regulatory sites such as Gaming Operations 302 via the API mode to retrieve and synchronize license information, as well as shipping regulations.

When an employee is due for renewal with a Gaming Operation 302, the data from their most recent application would be submitted by the Supplier Interface 306 to the Gaming Operation 302. A table of data field mappings would exist with each Gaming Operation 302 to ensure the correct data is placed in the correct data fields when transferred.

Employees of a Gaming Supplier 304 maintains their current data in the system 10 as changes are made, and with an annual review. It should be appreciated that this ensures the most current information for each employee is transmitted to each Gaming Operation 302.

A single master application, which would contain all of the necessary data fields, across all Gaming Operations 302, would be utilized by employees of the Gaming Supplier 304. This application would be delivered and managed by the system 100.

Gaming Suppliers 304 would also have a single point of reference for shipping regulations across all Gaming Operations 302, as well as a single point to initiate shipment requests to any of these Gaming Regulators 308.

As an option, the method 400 works with gaming regulatory jurisdictions that are not utilizing the system 100 to create their paper applications as a printable and exportable report for sending to these jurisdictions. It should be appreciated that this process would be automated as well to ensure compliance with licensure requirements.

In one embodiment, the method 400 includes the step 402 of logging in by a user of the computing device 102. The method 400 includes the step 404 of transmitting data from most recent employee application to the Gaming Operation 302 within the gaming environment. The method 400 includes the step 406 of accessing the system 100 and updating the employee application with any changes. For example, Gaming Suppliers 304 that need to manage their licensure and shipping rules for the Gaming Operation 302 have access to the system 100 to ensure the employees have compliance and approval by the Gaming Regulator 308 for the Gaming Operation 302.

The method 400 includes the step 408 of transmitting and managing the updated employee application by the system 100. For example, the Supplier Interface 306 manages licensure and shipping rules compliance for the Gaming Operation 302. The method 400 also includes the step 410 of ensuring compliance with licensure requirements based on the updated employee application. For example, the Supplier Interface 306 ensures compliance with licensure requirements based on the updated employee application for the Gaming Operation 302.

The method 400 further includes the step 412 of maintaining records of employee application through end of life. For example, the Gaming Supplier 304 will maintain a record of the employee application through their end of life for the Gaming Operation 302. The method 400 includes the step 414 of sending notices of non-compliance to the Gaming Supplier 304 and/or Gaming Operation 302. For example, if an employee application is revoked or determined non-compliant by the Supplier Interface 306, the Gaming Operation 302 and Gaming Regulator 308 will receive automated notices of the action, allowing them to take immediate action including removing the employee from the Gaming Operation 302. The method 400 then ends.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a database configured to store data from a Gaming Supplier and a Gaming Operation;
a computing system configured to communicate with the database; and,
an application executable by a processor of a computing device and to communicate with the computing system, wherein the application is configured to have the processor execute an algorithm of instructions to:
transmit data from most recent employee application to the Gaming Operation;
access the system by the Gaming Supplier to update the employee application with any changes;
transmit and manage the updated employee application by the system;
ensure compliance with licensure requirements based on the updated employee application;
maintain employee application through end of life; and
send notification to the Gaming Operation and the Gaming Supplier of non-compliance.

2. A system as set forth in claim 1 wherein a user of the computing device logs into the computing system with the computing device.

3. A system as set forth in claim 1 including a Supplier Interface that allows the Gaming Supplier to use and manage their licensure and shipping rules.

4. A system as set forth in claim 3 wherein the Supplier Interface manages licensure and shipping rules compliance for the Gaming Operation.

5. A system as set forth in claim 3 wherein the Supplier Interface ensures compliance with licensure requirements based on the updated employee application for the Gaming Operation.

6. A system as set forth in claim 5 wherein the Gaming Supplier will maintain a record of the employee application through their end of life for the Gaming Operation.

7. A system as set forth in claim 3 including a Gaming Regulator that receives licensure information from the Supplier Interface and communicates with the Gaming Supplier.

8. A system as set forth in claim 7 wherein the Gaming Supplier is allowed to access the system to ensure employees have compliance and approval by the Gaming Regulator for the Gaming Operation.

9. A system as set forth in claim 8 wherein the Gaming Regulator approves employee compliance for the Gaming Operation.

10. A system as set forth in claim 9 wherein if the employee application is revoked or determined non-compliant by the Supplier Interface, the Gaming Operation and Gaming Regulator will receive automated notices of the action, allowing them to take immediate action.

11. A method comprising the steps of:
storing, in a database, data associated with a Gaming Supplier and a Gaming Operation;
executing an application by a processor of a computing device to communicate with the computing system, wherein the application is configured to have the processor execute instructions:
transmitting, by a computing system, data from most recent employee application to the Gaming Operation;
accessing the computing system, by the Gaming Supplier, to update the employee application with any changes;
transmitting and managing, by the computing system, the updated employee application;
ensuring, by the computing system, compliance with licensure requirements based on the updated employee application;
maintaining, by the computing system, employee application through end of life; and
sending, by the computing system, notification to the Gaming Operation and the Gaming Supplier of non-compliance.

12. A method as set forth in claim 11 including the step of logging into the computing system by a user of the computing device.

13. A method as set forth in claim 11 including a Supplier Interface that allows the Gaming Supplier to use and manage their licensure and shipping rules.

14. A method as set forth in claim 13 wherein the Supplier Interface manages licensure and shipping rules compliance for the Gaming Operation.

15. A method as set forth in claim 13 wherein the Supplier Interface ensures compliance with licensure requirements based on an updated employee application for the Gaming Operation.

16. A method as set forth in claim 15 wherein the Gaming Supplier will maintain a record of the employee application through their end of life for the Gaming Operation.

17. A method as set forth in claim 13 including the step of a Gaming Regulator that receives licensure information from a Supplier Interface and communicates with the Gaming Supplier.

18. A method as set forth in claim 17 wherein the Gaming Supplier is allowed to access the system to ensure employees have compliance and approval by the Gaming Regulator for the Gaming Operation.

19. A method as set forth in claim 18 wherein the Gaming Regulator approves employee compliance for the Gaming Operation.

20. A method as set forth in claim 19 wherein if the employee application is revoked or determined non-compliant by the Supplier Interface, the Gaming Operation and Gaming Regulator will receive automated notices of the action, allowing them to take immediate action.
